(19) United States
(12) Patent Application Publication
(10) Pub. No.: US 2009/0042536 A1
(43) Pub. Date: Feb. 12, 2009

(54) Method and apparatus to manage femtocell traffic

(75) Inventors: Marc R. Bernard, Miramar, FL (US); Guy M. Merritt, Purcellville, VA (US); Douglas A. Atkinson, Ashburn, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellebs Vienna, Inc., Naperville, IL (US)

(21) Appl. No.: 11/986,560

(22) Filed: Nov. 21, 2007

Related U.S. Application Data
(60) Provisional application No. 60/964,016, filed on Aug. 8, 2007.

(51) Int. Cl. H04M 11/00; H04Q 7/20

(52) U.S. Cl. 455/406; 455/432.1

(57) ABSTRACT

Common techniques for processing cellular service uses a signal cellular tower, but these techniques are limited to the capacity of the single cellular tower. In contrast, a system employing an example embodiment of the invention increases ability to process cellular service by using an access point access network using resident wireless devices, referred to as a femtocell. A system supports communications of a resident and roaming device while employing the access point access network, based on database information, to support soft handoff between adjacent femtocells or from femtocell to cell tower and vice-versa. As a result, the system enables the resident and roaming devices to have seamless transitions between the cellular access network and the access point access network. Thus, the access point access network supplements cellular access networks and can provide cellular service regardless of the capacity of the cellular tower.

### RELATED APPLICATION

This application claims the benefit of U.S. Provisional Application No. 60/964,016, filed on Aug. 8, 2007. The entire teachings of the above application is incorporated herein by reference.

### BACKGROUND OF THE INVENTION

Cellular services typically use a single cell tower to provide service in a large geographical area. As the number of cellular users increase, the cellular tower's ability to handle additional cellular services for the cellular users is diminished. As a result, today's cellular towers become limited in the amount of cellular service that can be provided to cellular users. These limitations result in low quality cell service, high number of dropped or failed calls, unhappy customers, and high customer turnover for cell phone service providers.

### SUMMARY OF THE INVENTION

A method or corresponding apparatus in accordance with an example embodiment of the invention includes a cellular access network, access point access network, identifier module, and service module. In the example embodiment, the access point access network is in communication with the cellular access network to support soft handoff between the cellular access network and the access point access network. The access point access network includes a database configured with information identifying resident devices associated with the access point access network. The identifier module is configured to identify signals of the resident devices and roaming devices not normally associated with the access point access network. The service module is configured to access the database and assign characteristics of service to support communications of the resident and roaming devices while employing the access point access network based on the information in the database. The service module also supports soft handoff to enable the resident and roaming devices to have seamless transitions between the cellular access network and the access point access network.

A method or corresponding apparatus in accordance with an example embodiment of the invention providing a user with access point service. In operation, a service provider contracts with an access point agents to support wireless service for a third party via an access point in an access point access network. Next, the service provider contracts with the third party for the wireless service. As a result of the contracts, the service provider provides consideration to the access point agent for wireless service to the third party via the access points. The service provider then collects a fee from third party for the wireless service.

A method or corresponding apparatus in accordance with an example embodiment of the invention providing a wireless user with access point wireless service. In use, an access point agent contracts with a service provider to provide access to an access point in an access point access network for support of wireless service for customers of the service provider. Next, the service provider provides the customers of the service provider access to the access point access network and receives consideration from the service provider for providing the customers with access to the access point access network.

A method or corresponding apparatus in accordance with an example embodiment of the invention includes a soft handoff negotiation module configured to support soft handoff between an access point access network and a cellular access network. A database is configured with information identifying resident devices associated with the access point access network. Further an identifier module is configured to identify signals of the resident devices and roaming devices not normally being associated with the access point access network. The service module is configured to access the database and assign characteristics of service to support communications of the resident and roaming devices, communicating via the access point access network, based on the information in the database. The service module also supports soft handoff to enable the resident or roaming devices to have seamless transitions between the cellular access network and the access point access network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram depicting a cellular communications network carrying cellular signals between multiple nodes and a cellular tower;

FIG. 2 is a high level diagram depicting a cellular management network with a cellular management system interacting with one or more femtocell nodes according to an example embodiment of the invention;

FIG. 3 is an detailed view of a femtocell network environment in a geographical location providing coverage for resident (e.g., in-home) and roaming users according to example embodiments of the invention;

FIG. 4 is a block diagram of an example Optical Network Terminal (ONT) having an integrated femtocell according to example embodiments of the invention;

FIG. 5 is a flow diagram illustrating an example ONT supporting a roaming cellular device according to example embodiments of the invention;

FIG. 6 is a flow diagram illustrating an example ONT supporting a resident (e.g., in-home) cellular device according to example embodiments of the invention;

FIG. 7 is a flow diagram illustrating an example embodiment for managing a cellular device according to example embodiments of the invention;

FIG. 8 is a block diagram of a communications network managing devices according to example embodiments of the invention;

FIG. 9A is a block diagram depicting a service provider and third party contracting for access point service over an access point access network;

FIG. 9B is a block diagram depicting a cellular communications network carrying cellular signals and exchanging cellular service for consideration between multiple wireless nodes and a cellular tower in accordance with an embodiment of the invention; and

FIG. 10 is a flow diagram illustrating an example embodiment for a service provider providing femtocell service to a user for a fee in accordance with example embodiments of the invention.

### DETAILED DESCRIPTION OF THE INVENTION

A description of example embodiments of the invention follows.

Femtocells provide cellular access points connecting to a mobile operator's network using a residential Digital Subscriber Line (DSL) or cable broadband connections. A femtocell is an Access Point Base Station or, more generally, an access point access network node that is a scalable, multi-channel, two-way communication device. The femtocell extends a typical base station by incorporating each of the major components of the telecommunications infrastructure. A typical example of a femtocell is a Universal Mobile Telecommunications System (UMTS) access point base station containing a Node-B, Radio Network Controller (RNC), and other management nodes having an Ethernet or broadband connection to the Internet or Intranet.

One application of a femtocell is for transmitting data over Voice-Over-Internet Protocol (VoIP) to an access point access network. The application provides voice and data services in the same or substantially similar manner as a cellular base station, but with the deployment simplicity of a Wireless Fidelity (WiFi) access point. That is, the femtocell connects wireless communication devices together to form a wireless network. One benefit of using access point, such as a femtocell, is the simplicity of deployment, low-cost, and scalable design, which increases both capacity and coverage of the transmission. Moreover, access points can be stand-alone units that are typically deployed in hotspots, buildings, and homes resulting in an ability to use a wide variety of node locations. For example, a WiFi router can be attached to allow a WiFi hotspot, in one of many locations, to work as back-haul for a cellular hotspot, for example.

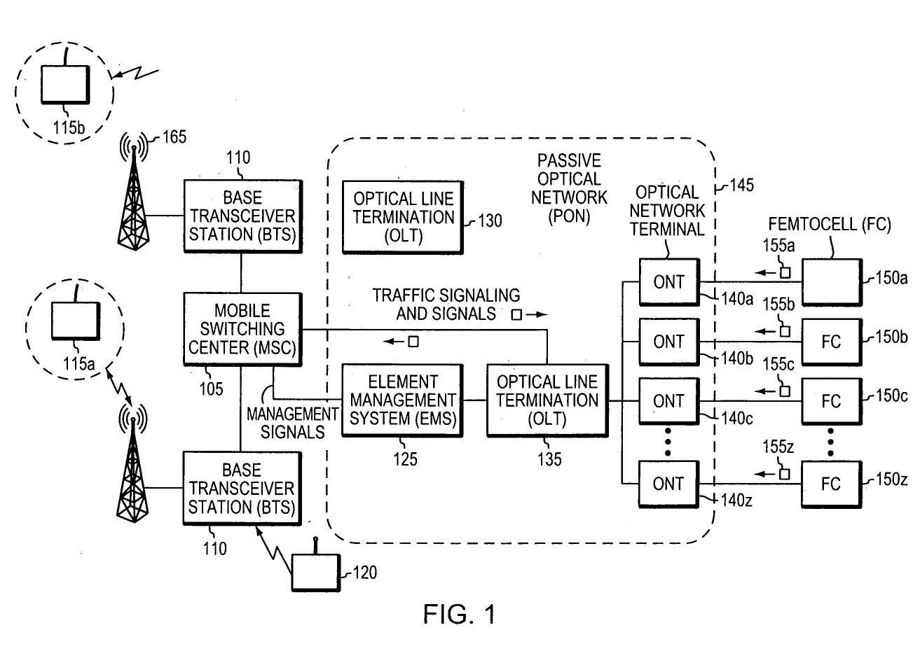

FIG. 1 is a block diagram depicting a cellular communications network 100 supporting cellular signals communicated between multiple wireless nodes 115 via a cellular tower 165 to other nodes (e.g., Optical Network Terminals (ONTs) 140a-z). The cellular communications network 100 includes a Base Transceiver Station (BTS) 110 connected to a Mobile Switching Center (MSC) 105. During end node communications, such as a call between two end user cellular devices 115a, 115b, the MSC 105 acts as a telephone exchange, which may provide circuit-switched calling, mobility management, and Global System for Mobile communications (GSM) services to a cellular phone 120, cellular devices 115a-b, or a cellular management network 150 in the service area of the cellular tower 165.

In an example embodiment, the MSC 105 communicates with a Passive Optical Network (PON) 145 and establishes a cellular service via one or more distributed Femtocells 150a-z. The PON 145 may include at least one Element Management System (EMS) 125, multiple Optical Line Termination(s) or Terminal(s) (OLTs) 130, 135, and one or more Optical Network Terminals (ONTs) 140a-140z. In use, the PON 150 receives cellular data 155a-z from a femtocell 150a-z and processes the cellular data 155 to establish a communications path (e.g., a wireless call) with a wireless device 120. That is, the PON 150 communicates with the MSC 105, or other suitable management node, to establish a connection between a user device, such as cell phone roaming/local or other wireless devices 120. For further convenience, the femtocell 150 may be integrated into various network nodes, such as the EMS 125 or the ONTs 140a-140z.

It should be understood that example embodiments of the invention can be employed to support equipment, such as cellular phone handsets, cellular devices 115a-b, wireless device 120, PON 150, Wireless Local Loop (WLL) phones, computers with wireless Internet connectivity, WiFi, and Worldwide Interoperability for Microwave Access (WiMAX) gadgets. Moreover, example embodiments of the invention can be employed with the cellular communications network 100 using wireless communications technologies, such as Global System for Mobile Communications (GSM), Code Division Multiple Access (CDMA), Wireless Local Loop (WLL), Wide Area Network (WAN), WiFi, WiMAX, and the like. It should be further understood that example embodiments presented herein may support the above listed technologies, other currently available technologies, or later developed technologies.

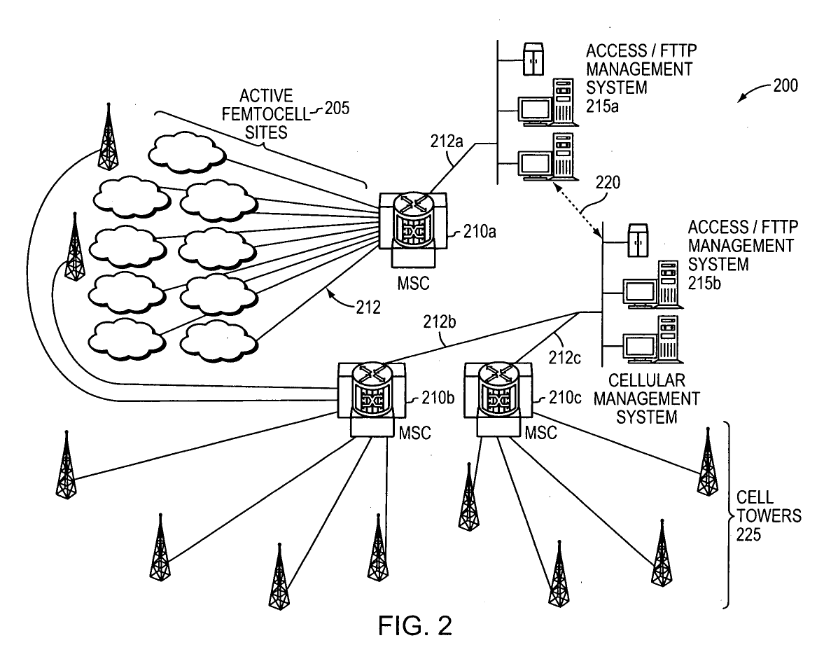

FIG. 2 is a high level diagram depicting a cellular management network 200 with an access/FTTP management system 215a-b interacting with one or more MSCs 210a-c supporting active femtocell sites 205 and cell towers 225. It should be understood that a femtocell may be referred to herein as a device (not shown) within a femtocell site 205 or the femtocell site 205 itself. In use, active femtocell sites 205 are installed in multiple locations, such as homes or other premises (e.g., office buildings, tunnels, subway stations, and so forth), and, in turn, are capable of servicing a small geographical location. Using example embodiments of the invention, the femtocell sites 205 may be combined in such a way to proxy and/or mimic a portion or an entire cellular servicing area and offload resident cellular users from cellular towers.

The femtocell sites 205 may also be used to provide service for resident (e.g., in-home) users as well as roaming user (i.e., a user not normally associated with a resident femtocell site 205), which can lessen burden of resident users from cell towers 225. As a result, the femtocell sites 205 can offload cellular traffic from the cell towers 225 and backhaul the cellular traffic to central offices (COs), such as where the MSCs 210a-c are located, via a wireline or fiber optic 212a-c or other non-cellular access technologies, such as PON, WiMAX, DSL, and the like. In this way, femtocell sites 205 increase network efficiency and reduce traffic from cell towers 225.

In an embodiment, the access/FTTP management systems 215a-c are Element Management Systems (EMSs) that facilitate communicating between the cellular and femtocell networks for management of femtocells sites 205. To manage the femtocells sites 205, the EMSs 215a-c store and communicate active cell information, user account information, and any additional information for processing and improving overall network management of cellular signals with cellular management system(s) (not shown). One benefit of storing this information is that the EMSs, using this information, can establish a connection and restore future connections seamlessly for a user (i.e., a user does not realize a femtocell site 205 is now being used for network access instead of the cell tower 225).

In the case of a femtocell device (not shown), which can also be a femtocell site 205, the femtocell device can be separate from the management of a resident user's services. Specifically, the femtocell device may be managed by an EMS or ONT. In operation, the EMS manages, via respective ONTs, cellular services provided by the femtocell device, ensuring that any additional EMS networks are aware of each active femtocell device in the network. As part of the management, interactions between EMSs may result in sharing at least some of the following example information: total users per hour, total average users, total bandwidth used, provisioning information, such as maximum users allowed per femtocell, enabling/disabling a femtocell site 205, alarming information, such as misbehaving femtocells, and the like. By sharing the information, each EMS is aware of cellular traffic and femtocell devices/sites 205 in the geographical location. Thus, each EMS can transfer service, without interruption, from a cellular tower to a femtocell site 205 in a seamless manner to the user.

In another example embodiment, a node, such as an ONT, has an interface to a separate cellular network management system for direct management of the femtocells. Further, the interface may be logically separated from the cellular network management system allowing the use of a separate management channel for sending messages. For example, the ONT can manage resident user services, via an ONT Management Communications Interface (OMCI) (e.g., interface of separate cellular network management channel), as well as other services using a separate management channel (e.g., a TR69 channel or the like).

In one embodiment, multiple (e.g., N) femtocells can simulate a single cellular tower by communicating with an OLT or ONT as a cellular would normally communicate. Each of the femtocells can be managed in the same way that a single cell tower is managed within a single cell site resulting in substantially the same service to an end user within a femtocell geographical coverage area. That is, in the femtocell geographical coverage area, N (e.g., 1000) femtocells span the same geographical area and provides the same user-capacity as a standard cellular tower. In use, an access system 215a-b managing a femtocell network is capable of communicating with a standard cellular management system (not shown) via wired, wireless, or fiber optic communications, for example, and providing relevant data that makes the femtocell geographical coverage area appear to be a cellular tower area. Information communicated between the femtocell and cellular management systems unnoticed by the users and resident “bonding” (i.e., logical grouping(s)) of the femtocell hosts is automatically managed by the respective access systems 215a-b.

Benefits are achieved for service providers by using a femtocell for servicing cellular signal of roaming users. Benefits for service providers, for example, include: having dual access and wireless networks, increased revenue by charging other wireless service providers a fee to access femtocell host networks, thus increasing revenue, and offloading cellular services in exchange for discounts or free services to femtocell hosts (i.e., access customers that have femtocells installed at their premises).

Yet another benefit of using femtocells to a service provider is that the femtocell employs power and backhaul via the host's existing resources. In particular, femtocells enable capacity equivalent to a full 3G network sector at very low transmit powers, dramatically increasing battery life of existing wireless phones accessing a wired communications network via a femtocell host device (i.e., access point), without needing to introduce WiFi enabled handsets. Femtocell technology may also offer greater network efficiency, better in-building wireless coverage, and a more suitable platform for fixed mobile convergence services than does a cellular network. Thus, femtocell technology obviates complexity and cost of WiFi in handsets. It should be understood that benefits are also achieved for hosts allowing the service provides to use femtocells. Benefits for hosts, for example, include: a payment or free Internet service from the service provider for use of the host's femtocell.

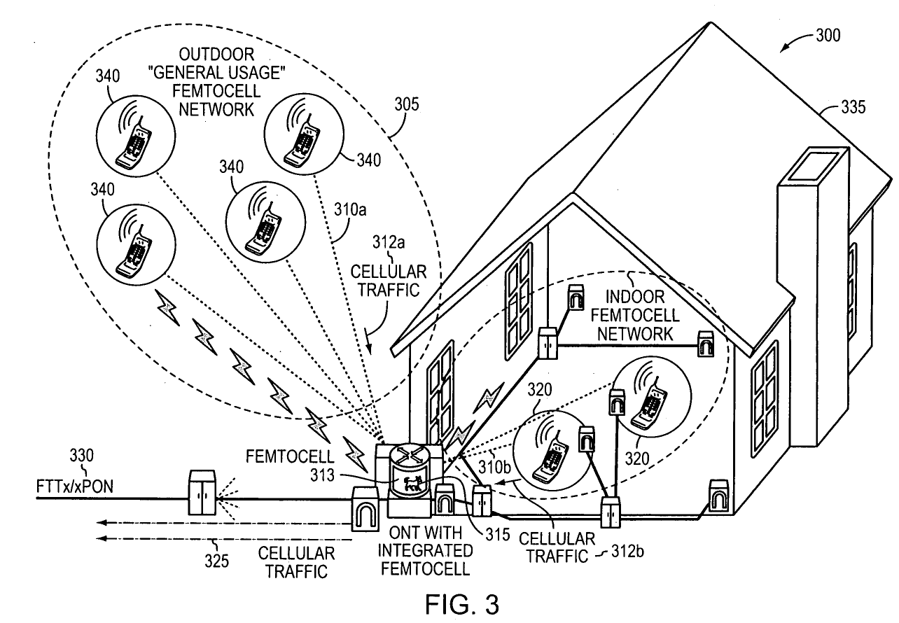

FIG. 3 is a detailed view of a femtocell network environment 300 in a geographical location providing coverage for resident and roaming users. In operation, a resident user 320 or a remote user 340 transmits cellular traffic 312a-b to a femtocell 313, within or connected to an ONT 315, over respective communications paths 310a-b. After receiving cellular traffic 312a-b, the ONT 315 directs the cellular traffic upstream to a PON 330 over a communications path 325 for processing.

In an embodiment, an ONT 315 has an integrated (or plugged-in) femtocell 313 (or similar wireless/cellular) technology. The ONT 315 distinguishes between the femtocell 313 host's cellular services (e.g., a resident user) and roaming users that may or may not have access to the femtocell's 313 access services. In particular, the ONT 315 stores or associates the resident user's equipment to a guaranteed service, which is separate from other cellular devices the ONT 315 can detect. As a result, the ONT 315 enables all resident users (possibly up to a predetermined maximum) to access the ONT's 315 network uplink or management services.

It is useful to note that a femtocell may be located in a particular geographical location to accommodate a resident user 320 within a home or office 335 and a roaming user 340 roaming outside 305 of the home or office 335. It is also useful to note that a roaming user is located within the geographical location area of the resident user 320. However, when the roaming user transmits beyond the geographical location area, the roaming user moves to a new available cellular location. The new available location can be a femtocell or cellular tower having a better signal for the wireless device in use and supporting a soft handoff from the previous available location access device and itself. Thus, embodiments of the invention can either perform a soft handoff between a cellular tower and a femtocell or between two femtocells while providing a seamless transition between adjacent femtocells.

It should be understood that embodiments of the present invention may also apply to similar technologies beyond femtocells, such as picocells or other variations. Specifically, a picocell is wireless communication system typically covering a small area, such as in-building (offices, shopping malls, train stations, etc.), or more recently in-aircraft whereas a femtocell is a scalable, multi-channel, two-way communication device extending a typical base station by incorporating all of the major components of the telecommunications infrastructure. In picocells, femtocells, and other similar technologies embodiments of the present invention may be employed.

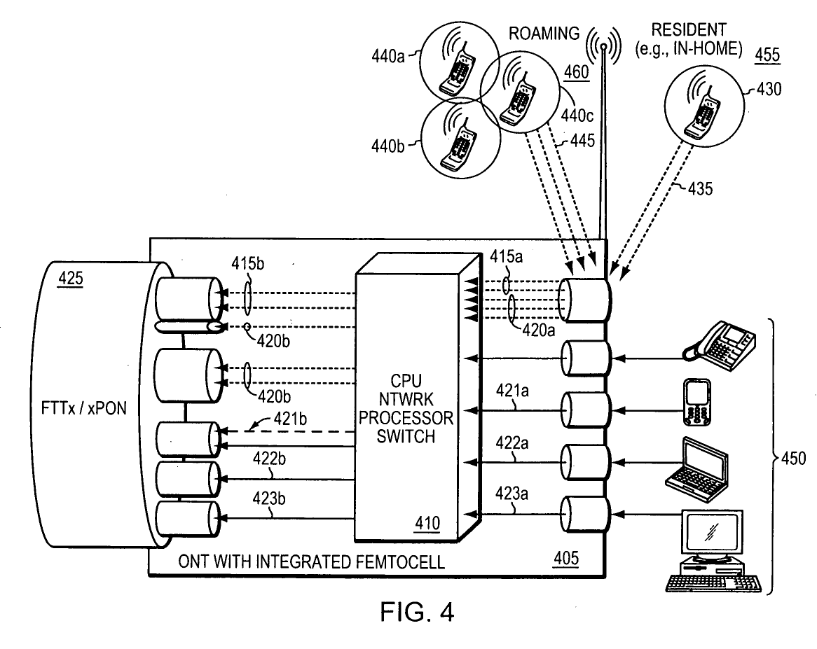

FIG. 4 is a block diagram 400 of an example Optical Network Terminal (ONT) having an integrated femtocell according to embodiments of the present invention. In particular, FIG. 4 shows the ONT 405 management distinguishing between a resident user 455 (e.g., in-home) cellular traffic and roaming cellular traffic. The ONT 405 directs in-home 455 or roaming 460 cellular traffic to different data flow nodes 415a-b or 420a-b based on the preferences typically configured by a service provider. For example, a service provider configures preferences indicating cellular device 430 is a resident device. Thus, the service provider transmits a resident user 455 (e.g., in-home) cellular signals for the cellular device 430 over a communications path 435 to a data flow node 415a. In turn, the data flow node 415a transmits the data through a network processor switch 410, having a femtocell, and provides the cellular data to a PON via a data flow node 415b based on the preferences. In this way, the service provider properly transmits signals from cellular device 430 by distinguishing between a resident user 455 (e.g., in-home) and roaming 460 devices. It is useful to note that other devices 450, such as an IP phone, handheld, laptop, or digital video recorder may also establish a wireless connection via respective data flows 421a-b, 422a-b, 423a-b.

In one embodiment, cellular traffic is on the same data flow 421a-b, but the cellular traffic is separate from other in-home access services such as video/data (H.323 Signaling Interface/traditional POTS voice). The cellular traffic, for example, may share the same data flow 421a-b as the resident user's in-home traffic. Sharing the same data flow 421a-b can be used for low cost devices or to provide in-home discounting to the resident user. In other embodiments, other cellular devices are sent up stream via a separate data flow (e.g. Virtual Local Area Networks (VLAN), Gigabit PON Emulation Mode (GEM) Port ID, or similar) that is separate from the resident user's services. It is useful to note that the data flow ports are adjustable to compensate for Quality of Service (QOS) for each device.

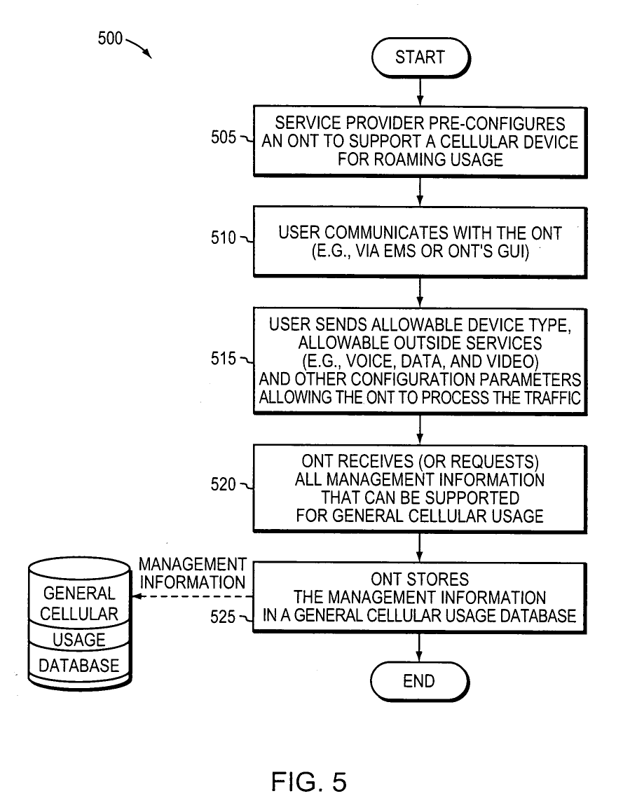

FIG. 5 is a flow diagram 500 illustrating an example ONT supporting a roaming cellular device according to example embodiments of the invention. In the example flow diagram 500, a service provider pre-configures an ONT to support a cellular device for roaming usage (505). Next, a user communicates with the ONT via an EMS or ONT interface (510). The user sends information, such as an allowable device type, allowable outside services (e.g., voice, data, and video), or other configuration parameters to the ONT allowing the ONT to process the traffic (515). In turn, the ONT receives (or requests) management information supported for general cellular usage (520). After receiving the management information, the ONT stores the management information in a general cellular usage database (525), thus configuring a cellular device for roaming usage. It is useful to note that if a user enables a “resident in-home cellular coverage” parameter is in-home, the ONT (or the EMS, or some other application) requests the management information from a database for each device registered as in-home. The management information for resident in-home users is typically located in a database other than the general cellular usage database.

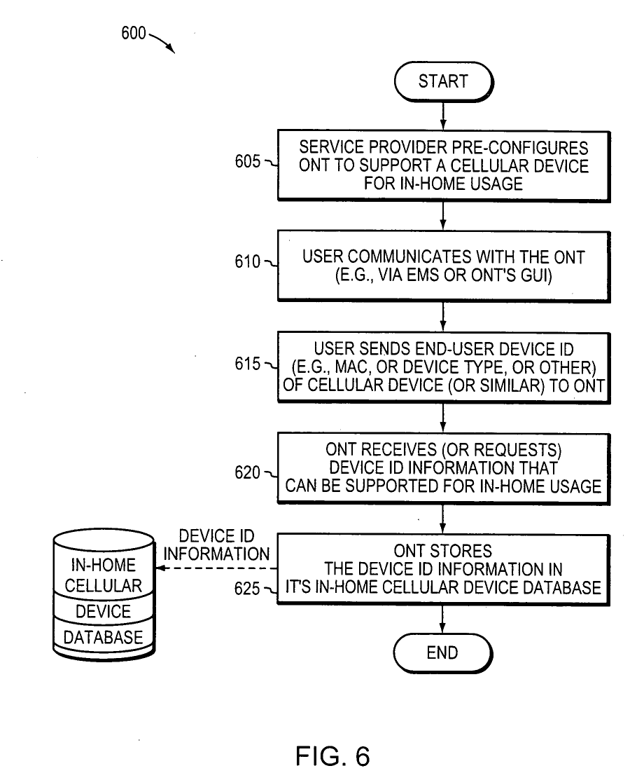

FIG. 6 is a flow diagram 600 illustrating an example ONT supporting a in-home cellular device according to an example embodiment of the invention. After beginning, the service provider pre-configures an ONT to support a cellular device for in-home usage (605). Next, the user communicates with the ONT (e.g., via an EMS or ONT's GUI) (610). After communicating with the ONT, the user sends an end-user device ID (e.g., a MAC, device type, or other identifier) of the cellular device to ONT (615). In turn, the ONT receives (or requests) device ID information for supporting an in-home usage (620). Once receiving the device ID, the ONT stores the device ID information in a database, such as an in-home cellular device database (625).

It is useful to note that the ONT discovers the type of cellular device in the coverage (e.g. femtocell) area. Next, the ONT communicates with a central server (optionally located within the service provider's network) to determine if the cellular device is allowable and what services (e.g., voice, data, video, etc.) are supported by the cellular device. Based on these communications, the ONT updates a resident database to manage traffic for the cellular device, accordingly. Cellular device traffic can then be managed as specified by the stored parameters from a database or other storage unit/memory.

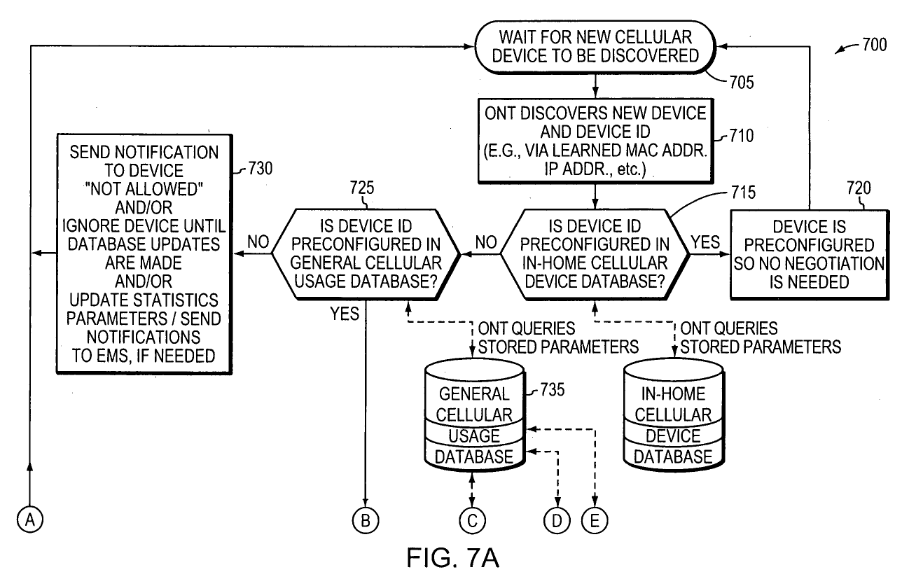

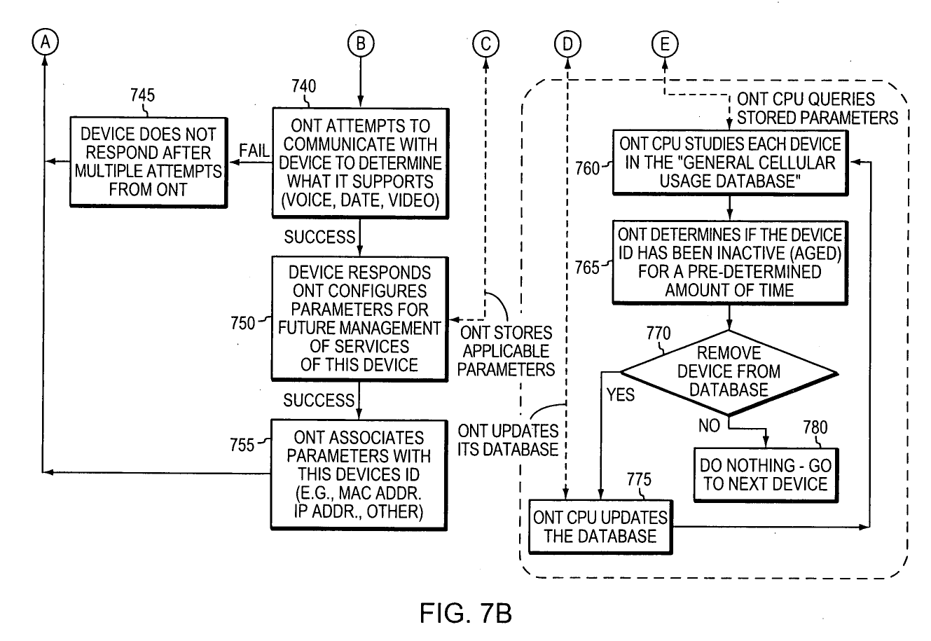

FIG. 7 is a flow diagram illustrating an example a process 700 for managing a cellular device according to an example embodiment of the invention. In particular, the process 700 waits for new cellular device to be discovered (705) and continues the process 700 once the ONT discovers a new device (710). The ONT, in discovering the new device, learns a device ID (e.g., a MAC address, IP address, or other identifier) for the device. Next, the process 700 determines if the device ID is preconfigured in a database or other storage unit, such as an in-home cellular device database (715), by querying the stored parameters. If so, the device is pre-configured, so the process 700 does not negotiate for a connection and configure the device (720). If not, the process 700 determines if the device ID is preconfigured in a different database, such as a general cellular usage database (725).

If the device ID is not preconfigured in the general cellular usage database, the ONT may do the following: send notification to the device indicating “not allowed”, ignore the device until database updates are made, update statistics parameters and send notifications to EMS, if appropriate (730), or some combination of any of the foregoing. If the device ID is preconfigured in general cellular usage database based on the ONT queries of stored parameters (735), the ONT attempts to communicate with the device and determines what data (e.g., voice, data, video) the cellular device supports (740). If the communication fails, the device is not responding after multiple attempts from the ONT and the ONT returns to waiting for a new cellular device (745). If the communication is successful, the ONT configures parameters for future management of services of this device (750) by sorting the applicable parameters in the general cellular usage database (735). Once the parameters are configured, the ONT may associate parameters with the devices ID (755). It is useful to note that the ONT or other PON network node, in cooperation with a cellular network (management) node, manages processing of cellular traffic, directing traffic to a specific flow, prioritization of traffic, collection of statistics and performance monitoring, and/or generation of alarms.

In one example embodiment, for maintaining the general cellular usage database, the ONT Central Processing Unit (CPU) reviews each device in the General Cellular Usage Database (760). Next, the ONT determines if the device ID has been inactive (e.g., aged) for a pre-determined amount of time (765) and should be removed from the database (770) (e.g., inactive). If the device is inactive, the ONT removes the device ID and updates the database (775); otherwise, no changes are made, and the ONT reviews the next device (780). It is useful to note that maintaining the database can be performed separate from discovering device IDs. It should be understood that the general cellular usage database is merely an example for illustrative purposes and any database, storage unit, or suitable memory can be used for storing the information.

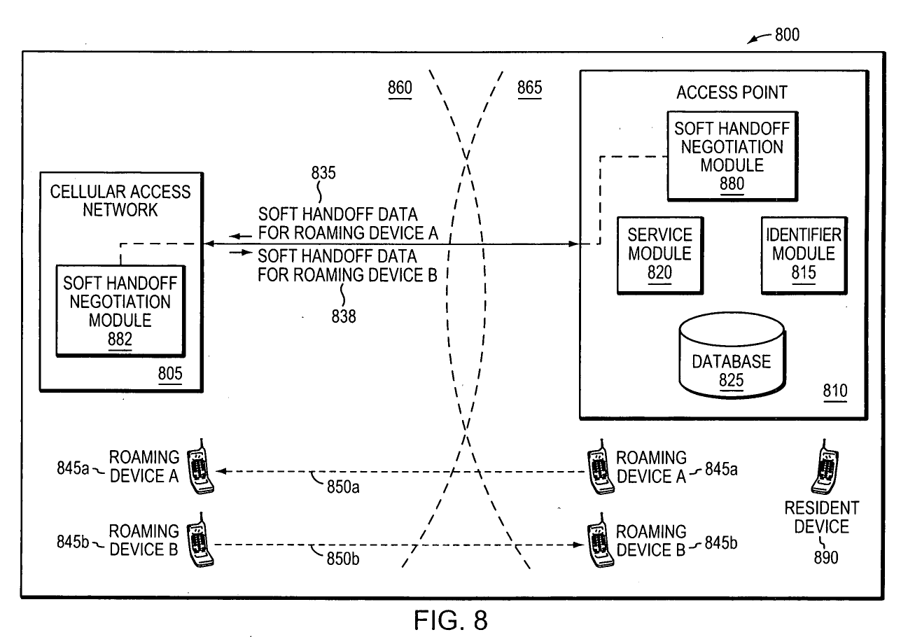

FIG. 8 is a block diagram of a communications network 800 managing devices according to an example embodiment of the invention. In particular, FIG. 8 shows a cellular access network 805, an access point 810, an identifier module 815, a service module 820, a soft handoff negotiation modules 880, 882. In one embodiment, the soft handoff negotiation module 880 sends soft handoff data 835 for a roaming device A 845a to the soft handoff negotiation module 882 (e.g., between the access point 810 and the cellular access network 805). In this way, a soft handoff via a communications network 800 is achieved.

In an example embodiment, a soft handoff refers to CDMA and WCDMA standards, where a cellular device is simultaneously connected to two or more cells (or cell sectors) during a call. This technique is a form of mobile-assisted handover, for cellular devices continuously making power measurements of a list of neighboring cell sites, and determine whether or not to request or end soft handover with an access point or cell sectors on the list.

In the example embodiment, CDMA subscriber station to simultaneously receive signals from two or more radio base stations that are transmitting the same bit stream on the same channel. If the signal power from two or more radio base stations is nearly the same, the subscriber station receiver can combine the received signals in such a way that the bit stream is decoded much more reliably than if only one base station were transmitting to the subscriber station. If any one of the signals fades significantly, there will be a relatively high probability of having adequate signal strength from one of the other radio base stations. It should be understood that the techniques of soft handoff can be applied to any number of different wireless standards (e.g., TDMA, GSM, and the like). It should be further understood that this invention provides a soft handoff between a cellular network and an Internet Protocol (IP) network node (e.g., an access point).

Moreover, embodiments could be applied to a gateway communicating with a base station or MSC. Other configurations are also possible, such as providing a soft handoff over a maintenance or management channel. Other embodiments can also employ an access point using a Session Initiation Protocol (SIP) is an application-layer control (signaling) protocol for creating, modifying, and terminating sessions with one or more cellular devices. A SIP embodiment can be used to create two-party, multiparty, or multicast sessions that include Internet telephone calls, multimedia distribution, and multimedia conferences.

Referring back now to FIG. 8, the access point 810 is in communication with the cellular access network 805 to support soft handoff by sending soft handoff data 838 between the soft handoff negotiation module 882 of the cellular access network 805 and the soft handoff negotiation module 880 of the access point 810. Zone boundaries 860, 865 are also visible to show a transition of service 850a, 850b between roaming devices 845a, b. That is, the access point 810 cellular access network 805 transitions roaming device A/B 845a to the access point 810 (e.g., an IP network node) for wireless service.

Likewise, a resident device 840 uses the access point 810 for wireless service. An identifier module 815 is configured to identify signals of the resident devices 840 and roaming (i.e., non-resident) devices 845a, b not normally associated with the access point 810. Further, the service module 820 accesses the database 825 and assigns characteristics of service to support communications of the resident devices 840 and roaming devices 845a, b. The service module 820 communicates via the access point 810 based on the information in the database and to support soft handoff to enable the resident devices 840 and roaming devices 845 to have seamless transitions between the cellular access network 805 and the access point 810.

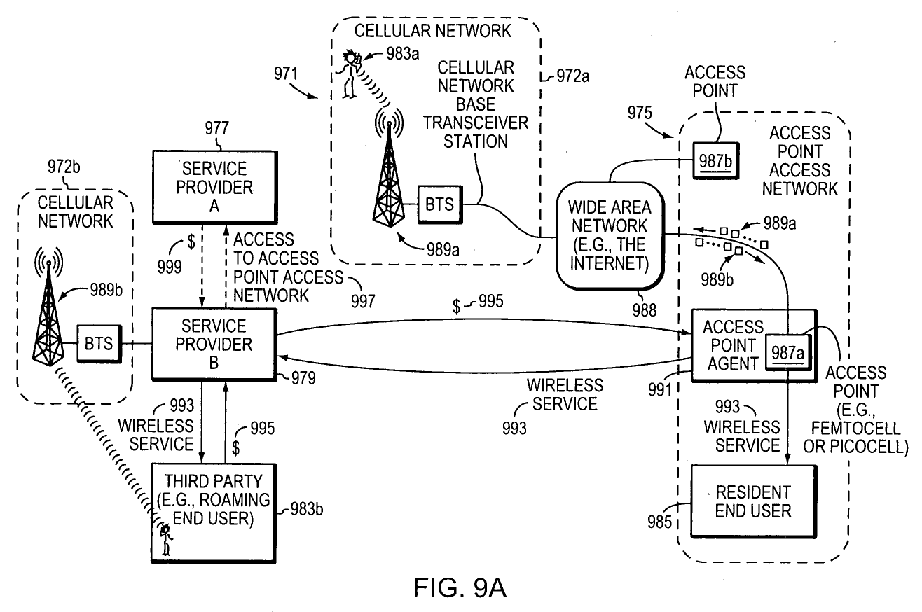

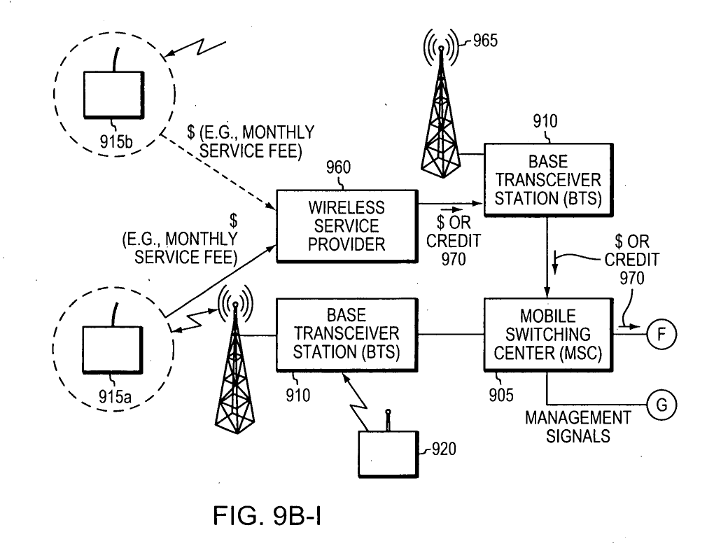

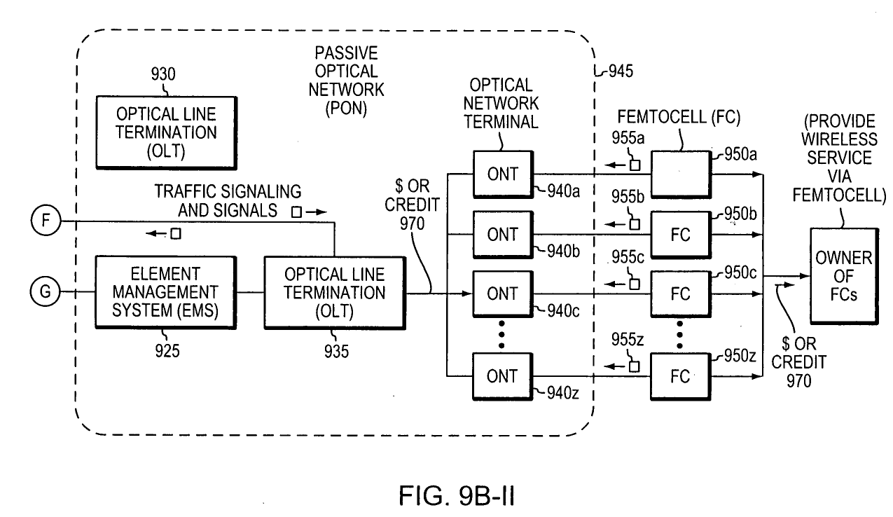

FIG. 9A is a block diagram depicting a communications network 971 that includes multiple parties and multiple networks, including cellular 972a, 972b, wide area network 988, and access point access network 975. A service provider and a third party (e.g., a roaming end user) contracting for access point service over an access point access network 975 where normally the service provider and third party contract between each other for wireless services via the service providers cellular networks 972a, 972b via base transceiver stations 989a, 989b. The access point access network 975 includes a service provider A 977, service provider B 979, third parties 983a, 983b, resident end user 985, and access points 987a, 987b. In operation, an access point agent 991 uses the access point 987 to provide wireless service 993 to customer(s) of the service provider B 979, such as the third party 983, in exchange for value (i.e., consideration 995 (e.g., a fee).

In this particular example, the service provider B 979 contracts with the access point agent 991 to allow its customers to access the access point 987 for wireless service 993. In turn, service provider B 979 provides the wireless service 993 to a wireless user, such as the third party 983, for the fee 995. Thus, the service provider B 979 enters into an agreement with the access point agent 991 for wireless service 993 via access to the access point 987. In this example embodiment, the resident end user 985, which can be the access point agent 991, also uses the access point 987 for wireless service 993. Thus, communications 989a, 989b, such as voice over Internet Protocol (VoIP) signals, can be supported, allowing wireless customers (i.e., the third parties to roam in and out of the cellular networks 972a, b and the access point access network 975.

It is useful to note that, in one embodiment, service provider B 979 may also provide access to an access point access network 997 (e.g., the access point access network), via the access point 987, to the service provider A 977 in exchange for value 999. By providing wireless service 993 to service provider A 977, service provider A 977 provides wireless service (not shown) to additional wireless users.

An example of a situation in which the service providers 977, 979 might want to contract with the access point agent(s) 991 is to extend coverage for its customers, such as deeper into large buildings or dense urban settings. Femtocells may add the extra coverage that customers want for work-time wireless access for cell phone or personal digital assistants, and making contracts with access point agents may be a best mode of providing such service.

FIG. 9B is a block diagram depicting a cellular communications network 900 carrying cellular signals and exchanging cellular service for consideration between multiple wireless nodes 915 and a cellular tower 965 to other nodes (e.g., Optical Network Terminals (ONTs) 940a-z). The cellular communications network 900 includes a Base Transceiver Station (BTS) 910 connected to a Mobile Switching Center (MSC) 905. During end node communications, such as a call between two end user cellular devices 915a, 915b, the MSC 905 acts as a telephone exchange, which may provide circuit-switched calling, mobility management, and Global System for Mobile communications (GSM) services to a cellular phone 920, cellular devices 915a-b, or a cellular management network 950 in the service area of the cellular tower 965.

In an example embodiment, the MSC 905 communicates with a Passive Optical Network (PON) 945 and establishes a cellular service via one or more distributed femtocells 950a-z. The PON 945 may include at least one Element Management System (EMS) 925, multiple Optical Line Termination(s) or Terminal(s) (OLTs) 930, 935, and one or more Optical Network Terminals (ONTs) 940a-940z. In use, the PON 950 receives cellular data 955a-z from a femtocell 950a-z and processes the cellular data 955 to establish a communications path (e.g., a wireless call) with a wireless device 920. That is, the PON 950 communicates with the MSC 905, or other suitable management node, to establish a connection between a user device, such as cell phone roaming/local or other wireless devices 920. Moreover, a network service provider 960, in consideration for use of the femtocell 950a-z, provides an each owner of the femtocell 950a-z a fee, credit, or other consideration 970 for use of their respective femtocell 950a-z.

In an example embodiment, the femtocell service fee may be a flat fee or a service-per-use fee (reciprocal fee), where a fee is charged by owners of the femtocell hosts to the network service provide 960 each time a roaming (also referred to herein as a remote user or subscriber) subscriber of the network service provider 960 accesses one of the femtocell hosts. Further, the fee for the service may be collected on a subscription basis ranging from a one time, daily, weekly, monthly, or annual subscription basis, invoicing the party for the fee, collecting the fee on a bandwidth basis, volume of data basis over a given period of time, or collecting the fee on a prepayment basis. Other arrangements are also possible.

To establish these type of fee agreements, a cellular management system, such as the cellular management system of FIG. 2, or an EMS may perform the appropriate accounting of performance monitoring statistics for traffic, minutes, users, and other relevant data. Specifically, in this example embodiment, a service module or other element of the EMS collects performance monitoring statistics of roaming and other devices and provides the statistics to a management element of the EMS. The performance monitoring statistics can be stored in a database or other suitable memory for later review/use.

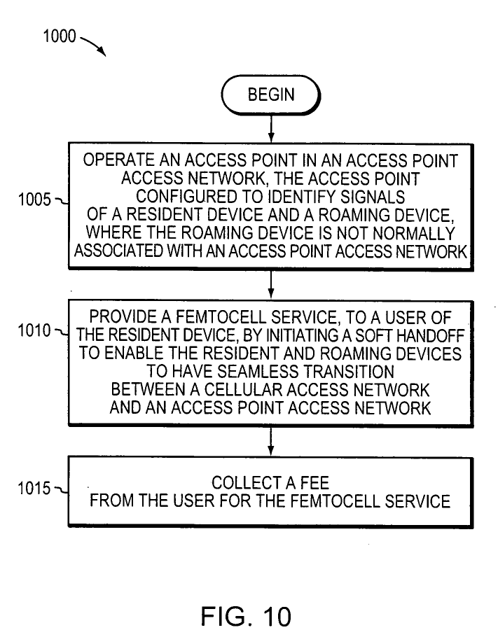

FIG. 10 is a flow diagram illustrating an example embodiment for a service provider providing femtocell service to a user for a fee in accordance with example embodiments of the invention. After beginning, a process 1000 operates an access point in an access point access network. The access point is configured to identify (1005) signals of a resident device and a roaming device, where the roaming device is not normally associated with an access point access network. After identifying the signals, the process 1000 provides a femtocell service (1010), to a user of the resident device, by initiating a soft handoff to enable the resident and roaming devices to have seamless transitions between a cellular access network and an access point access network. After providing a femtocell service, the provider of the femtocell service collects a fee (1015) from the user for femtocell service. It should be understood that the fee may also be collected from the service provider of the user for the femtocell service. Further, the flow diagram may include operations (not shown), such as data collection and reporting, consistent with invoicing for the fee or other consideration (i.e., value).

It should be understood that any of the processes disclosed herein, such as the managing network devices, inspecting traffic, or flow diagrams of FIGS. 5, 6, 7, and 10, may be implemented in the form of hardware, firmware, or software. If implemented in software, the software may be processor instructions in any suitable software language and stored on any form of computer readable medium. The processor instructions are loaded and executed by a processor, such as a general purpose or application specific processor, that, in turn, performs the example embodiments disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A communications network, comprising:
a cellular access network;
an access point access network at least in communication with the cellular access network to support soft handoff between the access point access network and the cellular access network and having a database configured with information identifying resident devices associated with the access point access network;
an identifier module configured to identify signals of the resident devices and roaming devices, where the roaming devices are not normally associated with the access point access network; and
a service module to access the database and assign characteristics of service to support communications of the resident and roaming devices while employing the access point access network based on the information in the database and to support soft handoff to enable the resident and roaming devices to have seamless transitions between the cellular access network and the access point access network.

2. The network of claim 1 wherein the access point access network is one or more femtocells.

3. The network of claim 1 wherein the service module is configured to collect performance monitoring statistics of roaming devices and to provide the statistics to a management element.

4. The network of claim 1 wherein the identifier module is configured to store a device ID for the roaming devices in the database for later configuration.

5. The network of claim 1 wherein the service module configures separate flow paths for the communications of the resident devices and roaming devices.

6. The network of claim 1 wherein the access point access network is configured to provide access to the roaming devices in exchange for a fee.

7. The network of claim 1 wherein the access point access network uses power and/or backhaul from existing resources.

8. The network of claim 1 wherein the access point access network is configured to enable a capacity of the cellular access network at low transmission power to increase battery life.

9. The network of claim 1 wherein a user allows the sharing of data flow in the access point access network.

10. A method for managing femtocell traffic comprising:
communicating with a cellular access network to support soft handoff between an access point access network and the cellular access network;
configuring a database with information identifying resident devices associated with the access point access network;
configuring an identifier module to identify signals of the resident devices and roaming devices not normally associated with the access point access network;
accessing the database and assigning characteristics of service to support communications of the resident and roaming devices;
employing the access point access network for service based on the information in the database; and
supporting soft handoff to enable the resident and roaming devices to have seamless transitions between the cellular access network and the access point access network.

11. The method of claim 10 wherein the access point access network is one or more femtocells.

12. The method of claim 10 further comprising:
collecting performance monitoring statistics of roaming devices; and
providing the statistics to a management element.

13. The method of claim 10 further comprising storing a device ID for the roaming devices in the database for later configuration.

14. The method of claim 10 further comprising separating flow paths for the communications of the resident devices and roaming devices.

15. The method of claim 10 further comprising accessing the roaming devices, using the access point access network, in exchange for a fee.

16. The method of claim 10 further comprising using power and/or backhaul from existing resources to power the access point access network.

17. The method of claim 10 further comprising enabling a capacity of the cellular access network for low transmission power to increase battery life.

18. The method of claim 10 wherein a user allows the sharing of data flow in the access point access network.

19. A method for providing a wireless user with access point service, comprising:
contracting with access point agents to support wireless service via an access point in an access point access network;
contracting with a third party for the wireless services;
providing consideration to the access point agents for wireless service to the third party via the access points; and
collecting a fee from the third party for the wireless service.

20. A method as claimed in claim 19 wherein access point agents are at least one of the following: an owner of an access point, a lessee of an access point, a lessor of an access point, an individual, a business entity, or a corporate entity.

21. A method as claimed in claim 19 wherein contracting with the access point agents further including contracting with the agents to operate the access point in the access point access network in a manner in which the access point identifies signals of a resident device and a roaming device, the roaming device not normally being associated with the access point access network.

22. A method as claimed in claim 19 further including collecting an additional fee from the third party for a soft handoff for seamless transitions between a cellular access network and the access point access network.

23. A method as claimed in claim 19 wherein collecting the fee from the third party includes at least one of the following: collecting the fee on a subscription basis ranging from a one time, daily, weekly, monthly, or annual subscription basis, invoicing the party for the fee, collecting the fee on a bandwidth basis, volume of data basis over a given period of time, or collecting the fee on a prepayment basis.

24. A method as claimed in claim 19 wherein the access point is a femtocell or picocell.

25. A method for providing a wireless user with access point wireless service, comprising:
contracting with a service provider to provide access to an access point in an access point access network for support of wireless service for customers of the service provider;
providing the customers of the service provider access to the access point access network; and
receiving consideration from the service provider for providing the customers with access to the access point access network.

26. An apparatus to manage femtocell traffic comprising:
a soft handoff negotiation module configured to support soft handoff between an access point access network and a cellular access network;
a database configured with information identifying resident devices associated with the access point access network;
an identifier module configured to identify signals of the resident devices and roaming devices, the roaming devices not normally being associated with the access point access network; and
a service module to access the database and assign characteristics of service to support communications of the resident and roaming devices, communicating via the access point access network, based on the information in the database and to support soft handoff to enable the resident or roaming devices to have seamless transitions between the cellular access network and the access point access network.

27. An apparatus as claimed in claim 26 wherein the access point access network includes one or more femtocells.

28. An apparatus as claimed in claim 26 wherein the service module is configured to collect performance monitoring statistics of roaming devices and to provide the statistics to a management element.

29. An apparatus as claimed in claim 26 wherein the identifier module is configured to store a device ID corresponding to the roaming devices in the database for later configuration.

30. An apparatus as claimed in claim 26 wherein the service module is configured to configure separate flow paths for the communications of the resident devices and roaming devices.

31. An method for managing femtocell traffic comprising:
configuring a database with information identifying resident devices associated with an access point access network;
configuring an identifier module to identify signals of the resident devices and roaming devices not normally associated with the access point access network;
accessing the database and assigning characteristics of service to support communications of the resident and roaming devices;
supporting communications via the access point access network for the roaming devices based on the information in the database; and
supporting soft handoff to enable the resident or roaming devices to have seamless transitions between a cellular access network and the access point access network.

32. The method of claim 31 wherein the access point access network includes at least one femtocells.

33. The method of claim 31 further comprising:
collecting performance monitoring statistics of roaming devices; and
providing the statistics to a management element.

34. The method of claim 31 further comprising storing a device ID corresponding to the roaming devices in the database for later configuration.

35. The method of claim 31 further comprising separating flow paths for the communications of the resident devices and roaming devices.

36. The method of claim 31 further comprising supporting access for the roaming devices to use the access point access network in exchange for a fee.
